(19) United States
(12) Patent Application Publication
(10) Pub. No.: US 2021/0124666 A1
(43) Pub. Date: Apr. 29, 2021

(54) INFORMATION PROCESSING SYSTEM

(71) Applicant: FUJI XEROX CO., LTD., Tokyo (JP)

(72) Inventor: Akihito MATSUZAWA, Kanagawa (JP)

(73) Assignee: FUJI XEROX CO., LTD., Tokyo (JP)

(21) Appl. No.: 16/852,833

(22) Filed: Apr. 20, 2020

(30) Foreign Application Priority Data
Oct. 29, 2019 (JP) 2019-196709

(51) Int. Cl. G06F 11/32; G06F 11/34

(52) U.S. Cl. CPC G06F 11/328; G06F 11/3476; G06F 11/3423

(57) ABSTRACT

An information processing system includes a processor configured to display pieces of time series information regarding respective work processes on a display, receive designation of timeframes of the respective work processes, determine comparison points respectively included in the designated timeframes of the respective work processes. The processor is also configured to, for each work process represented by multiple pieces of work data to be compared, mutually correlate the designated timeframes corresponding to each other, mutually correlate the determined comparison points corresponding to each other, and calculate a relative temporal position of each comparison point in the corresponding timeframe. The processor is also configured to make uniform a length of each timeframe of a corresponding one of the work processes and display, on the display, each piece of time series information indicating the comparison point at the relative temporal position.

### CROSS-REFERENCE TO RELATED APPLICATIONS

This application is based on and claims priority under 35 USC 119 from Japanese Patent Application No. 2019-196709 filed Oct. 29, 2019.

### BACKGROUND

### (i) Technical Field

The present disclosure relates to an information processing system.

### (ii) Related Art

The progress and management of the work have been supported in such a manner that data regarding a work process is managed by a computer and a timeline for the work process is displayed on a display.

Japanese Unexamined Patent Application Publication No. 2009-282557 discloses a screen generation device for analyzing project management information. In the screen generation device, multiple unit lines are displayed at respective positions on the time axis. The unit lines are generated for each person and each act that are to be managed and includes act information for project management. Multiple time tabs to respectively serve as base points for relative time display are added at the positions of respective desired time points on the respective displayed unit lines. The multiple unit lines are displayed in relative time and updated in the following manner. The multiple added time tabs are designated, the positions of the respective time tabs of one of the multiple unit lines that serves as reference are aligned with the positions of the respective time tabs of the other unit lines, and the one unit line partially overlaps the other unit lines.

### SUMMARY

When timelines in the same timescale are compared in comparing multiple work processes, it is difficult to know the progresses of respective events in the total work processes. In addition, it is troublesome to manually correlate events that are respective progress comparison targets with each other.

Aspects of non-limiting embodiments of the present disclosure relate to comparison enabled between timelines of respective work processes by using relative timeframes and reduction in an effort to display the timelines.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to display pieces of time series information regarding respective work processes on a display, receive designation of timeframes of the respective work processes, determine comparison points respectively included in the designated timeframes of the respective work processes. The processor is also configured to, for each work process represented by multiple pieces of work data to be compared, mutually correlate the designated timeframes corresponding to each other, mutually correlate the determined comparison points corresponding to each other, and calculate a relative temporal position of each comparison point in the corresponding timeframe. The processor is also configured to make uniform a length of each timeframe of a corresponding one of the work processes and display, on the display, each piece of time series information indicating the comparison point at the relative temporal position.

### BRIEF DESCRIPTION OF THE DRAWINGS

An exemplary embodiment of the present disclosure will be described in detail based on the following figures, wherein:

FIG. 1 is a diagram illustrating the overall configuration of an information processing system to which this exemplary embodiment is applied;

FIG. 2 is a diagram illustrating the functional configuration of a work management system;

FIG. 3 is a diagram illustrating an example hardware configuration of the work management system;

FIG. 4 is a flowchart illustrating the operation of the work management system;

FIG. 5 is a diagram illustrating an example of timeline display;

FIGS. 6A and 6B are diagrams illustrating an example method for designating base points of a work process; FIG. 6A is a diagram illustrating the structure of a work process, FIG. 6B is a diagram illustrating timeline display;

FIGS. 7A and 7B are diagrams illustrating a different example method for designating base points of a work process; FIG. 7A is a diagram illustrating the structure of the work process; FIG. 7B is a diagram illustrating timeline display;

FIGS. 8A and 8B are diagrams illustrating a different example method for designating base points of a work process; FIG. 8A is a diagram illustrating the structure of the work process; FIG. 8B is a diagram illustrating timeline display;

FIGS. 9A and 9B are diagrams illustrating a different example method for designating base points of a work process; FIG. 9A is a diagram illustrating the structure of the work process; FIG. 9B is a diagram illustrating timeline display;

FIG. 10 is a diagram illustrating an example of timeline display used for work-process progress prediction; and

FIG. 11 is a diagram illustrating an example of timeline display used for work process evaluation.

### DETAILED DESCRIPTION

### System Configuration

Hereinafter, an exemplary embodiment of the present disclosure will be described in detail with reference to the attached drawings.

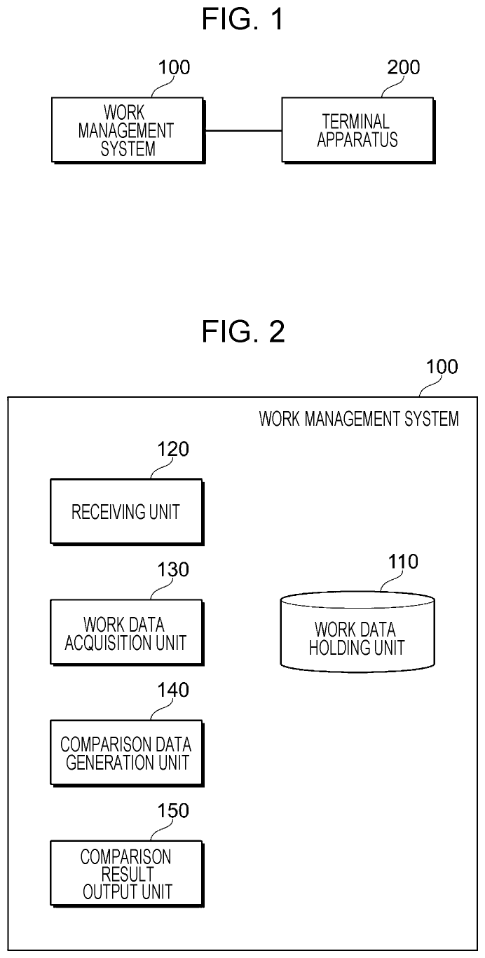

FIG. 1 is a diagram illustrating the overall configuration of an information processing system to which this exemplary embodiment is applied. The information processing system of this exemplary embodiment includes a work management system 100 and a terminal apparatus 200.

The work management system 100 is a server that manages information regarding work processes. The work processes to be managed include a work process performed in the past, a work process in progress, a work process scheduled to be performed in future, and other work processes. The work management system 100 is implemented as, for example, a server configured on a network. The configuration of the work management system 100 is not limited to a configuration using a piece of hardware (such as a server machine) and may a distributed configuration using multiple pieces of hardware and a virtual machine. The work management system 100 may be implemented as a local system or by using a cloud service or the like.

The terminal apparatus 200 is an information processing apparatus for inputting and outputting information to and from the work management system 100. The terminal apparatus 200 is implemented as, for example, a personal computer, or a smartphone. The terminal apparatus 200 includes a receiving unit and receives input of setting information and the like for a timeline by a user. As the receiving unit, for example, input devices such as a keyboard, a mouse, and a touch panel and a controller for the input devices are provided. The terminal apparatus 200 also includes a display and thus displays a work process timeline generated by the work management system 100. The timeline is time series information regarding a work process.

### Functional Configuration of Work Management System 100

FIG. 2 is a diagram illustrating the functional configuration of the work management system 100. The work management system 100 includes a work data holding unit 110, a receiving unit 120, a work data acquisition unit 130, a comparison data generation unit 140, and a comparison result output unit 150.

The work data holding unit 110 holds data regarding pieces of work to be managed and the process of each piece of work (work process). Although the work management system 100 includes the work data holding unit 110 in the example configuration illustrated in FIG. 2, an external storage server provided separately from the work management system 100 may be used as the work data holding unit 110.

The receiving unit 120 receives a command from the terminal apparatus 200. The command transmitted from the terminal apparatus 200 includes a command for designating work to undergo timeline display processing (hereinafter, referred to as target work) and a command for designating base points to be displayed in the timeline of a work process. The base points are points respectively determined as a start position and an end position that determine a timeframe of the work process for timeline display in the work. Several base-point setting bases such as an event occurrence time point in the work process and a work segment are conceivable but are described later in detail.

The work data acquisition unit 130 acquires, from the work data holding unit 110, data regarding target work designated in the command received by the receiving unit 120. In addition, the work data acquisition unit 130 determines comparison points to be displayed in the timeline of the target work and acquires data regarding the determined comparison points from the work data holding unit 110. Each comparison point is a time point at which a specific event or the like occurs in the work process of the target work. An event or the like serving as the comparison point is predetermined in accordance with the type of the target work and occurs in common in each work process. Accordingly, the comparison points as events or the like in the respective work processes of pieces of target work are correlated with each other. Comparison between the correlated comparison points in the respective work processes enables comparison between the progresses in a timeframe of the work process.

The comparison data generation unit 140 generates a comparison screen for comparing, in timelines, the respective work processes of the pieces of target work designated in the command received by the receiving unit 120. In the comparison screen, the comparison data generation unit 140 makes, of uniform length, the timeframes of the respective work processes of the pieces of target work and generates timelines. In each timeline, comparison points in the corresponding work process are each arranged at a relative temporal position in the corresponding timeframe of the work process. In more detail, the comparison data generation unit 140 first extracts, from the work information acquired from the work data holding unit 110, time information regarding the start position and the end position of the timeframe of the work process. The start and end positions are base points. The time information regarding the start position and the end position indicates time in which events or the like respectively designated as the start position and the end position are performed. After acquiring the time information regarding the base points, the comparison data generation unit 140 calculates time of the entire timeframe in the work process from the acquired time information regarding the base points.

In addition, the comparison data generation unit 140 mutually correlates comparison points corresponding to each other regarding an event or the like in the respective work processes of the pieces of target work. For each piece of target work, the comparison data generation unit 140 extracts, from the comparison point information acquired from the work data holding unit 110, time information regarding the corresponding comparison point (an occurrence time point of an event or the like) included in the corresponding timeframe of the work process. Further, the comparison data generation unit 140 calculates a relative temporal position of the comparison point in the timeframe of the work process from the acquired comparison point time information. The relative temporal position of the comparison point is expressed on the basis of, for example, a percentage of a temporal length from the start position of the timeframe to the comparison point compared to the temporal length of the entire timeframe in the work process.

In addition, the comparison data generation unit 140 generates a timeline of each work process on the basis of the result of the calculation result. Regardless of time actually taken to perform the work process, the comparison data generation unit 140 makes uniform the length of each timeline of the corresponding work process. In the timeline of the work process, each comparison point is arranged at the relative temporal position obtained by the calculation described above.

The comparison result output unit 150 generates the timeline display screen representing the result of a comparison between the work processes of the respective pieces of target work and transmits the screen to the terminal apparatus 200 to display the screen. In the timeline display screen, timelines of the respective work processes of the pieces of target work are arranged in parallel in such a manner that the start position and the end position of the timeframe of each timeline are aligned with those of the other timelines. In the timeline, the comparison points are clearly expressed at positions arranged by the comparison data generation unit 140.

The comparison result output unit 150 also generates a prediction screen for predicting the progress of a work process to be performed (referred to as a scheduled work process) and transmits the prediction screen to the terminal apparatus 200 to display the prediction screen. The prediction screen is generated by processing a timeline display screen generated on the basis of the timeline of a work process that is performed in the past and that is of a type identical to that of the scheduled work process. The comparison result output unit 150 also generates an analysis screen for analyzing and evaluating the progress of a past work process and transmits the analysis screen to the terminal apparatus 200 to display the analysis screen. The analysis screen is generating by processing a timeline display screen generated on the basis of the timeline of a work process regarding specific work performed in the past.

### Hardware Configuration of Work Management System 100

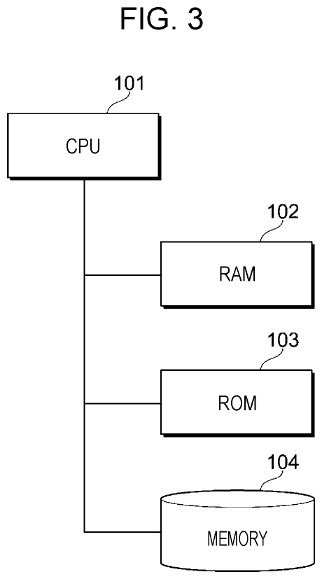

FIG. 3 is a diagram illustrating an example hardware configuration of the work management system 100. The work management system 100 includes a central processing unit (CPU) 101 that is an arithmetic unit and implemented by a computer. The work management system 100 also includes a random access memory (RAM) 102, a read only memory (ROM) 103, and a memory 104 that are memories. The RAM 102 is a main memory and is used as a work memory for the CPU 101 to perform arithmetic operations. The ROM 103 holds programs and data such as set values prepared in advance. The CPU 101 may read a program and data directly from the ROM 103 to thereby perform processing. The memory 104 is a unit for storing the programs and the data. The memory 104 stores the programs, and the CPU 101 loads a program stored in the memory 104 into the main memory and thereby runs the program. the memory 104 also stores the result of processing by the CPU 101. As the memory 104, for example, a magnetic disk device, a solid state drive (SSD), or the like is used.

In a case where the work management system 100 is implemented by the computer illustrated in FIG. 3, for example, the CPU 101 runs a program, and thereby the respective functions of the receiving unit 120, the work data acquisition unit 130, the comparison data generation unit 140, and the comparison result output unit 150 are implemented. In a case where the work management system 100 includes the work data holding unit 110, the work data holding unit 110 is implemented by, for example, the memory 104.

### Operation of Work Management System 100

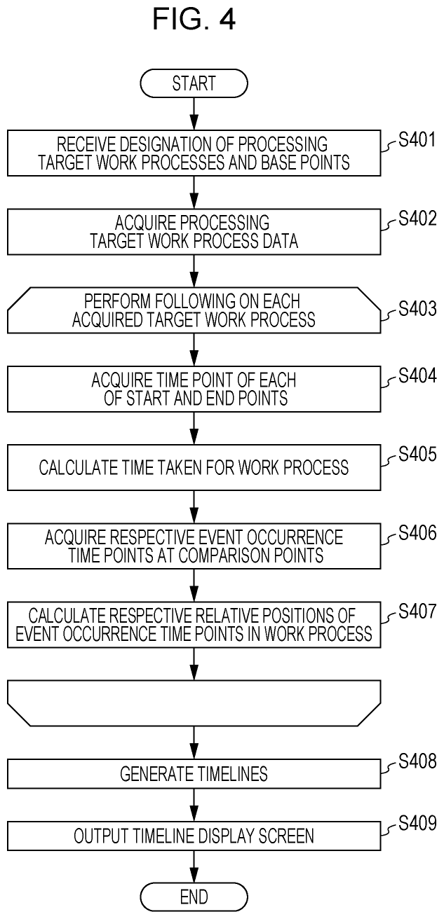

FIG. 4 is a flowchart illustrating the operation of the work management system 100. After the receiving unit 120 receives the designation of work processes to be processed and base points from the terminal apparatus 200 in the work management system 100 (S401), the work data acquisition unit 130 acquires data regarding the designated work processes from the work data holding unit 110 (S402). The comparison data generation unit 140 then performs the following processing on each piece of target work for which the data is acquired (S403).

The comparison data generation unit 140 focuses attention on an unprocessed piece of target work, and acquires, from the data acquired in step S402, implementation time points of respective events or the like as the start position and the end position (the start point and the end point in FIG. 4) that are the base points (S404). The comparison data generation unit 140 calculates time taken to perform the work process of the target work on the basis of the acquired implementation time points (S405). The comparison data generation unit 140 then acquires the occurrence time points of the events or the like as the comparison points in the work process (S406). The comparison data generation unit 140 calculates the relative positions of the event occurrence time points in the work process (S407).

After the processing is performed on every work process of the target work, the comparison data generation unit 140 generates a timeline of each work process (S408). In the timeline, the comparison points are arranged at the relative positions calculated in step S407. The comparison result output unit 150 then generates and outputs a timeline display screen having the timelines of the respective work processes arranged in parallel (S409) and causes the terminal apparatus 200 to display the timeline display screen.

### Example Timeline Display

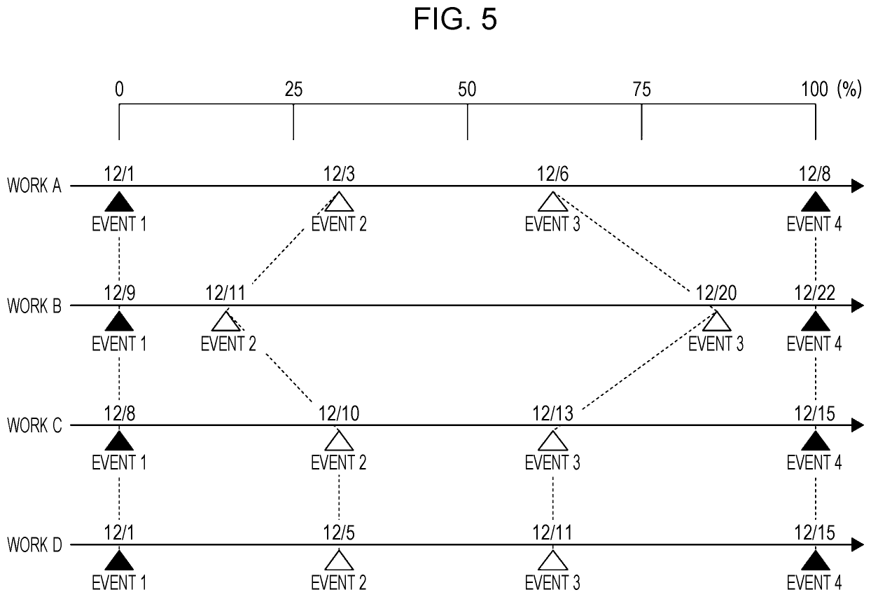

FIG. 5 is a diagram illustrating an example of timeline display. As illustrated in FIG. 5, in the timeline display, timelines respectively generated for the work processes of the respective pieces of target work are arranged in parallel in such a manner that the start position and the end position that are the base points in each timeline are aligned with those of the other timelines to have a uniform total timeline length. FIG. 5 illustrates timelines of respective work processes for four pieces of target work that are work A to work D. In each timeline, comparison points are arranged at relative positions in accordance with a timeframe of the timeline. Specifically, each timeline includes the event “Event 1” designated as a base point and set as the start position, the events “Event 2” and “Event 3” serving as the comparison points, and the event “Event 4” designated as a base point and set as the end position.

A period of time in which the work process displayed in the timeline is actually performed varies with the work. The work A takes 7 days from December 1 to December 8, the work B takes 13 days from December 9 to December 22, the work C takes 7 days from December 8 to December 15, and the work D takes 14 days from December 1 to December 15. However, in the timeline display, each timeline is displayed in such a manner that the event “Event 1” at the start position and the event “Event 4” at the end position are aligned with those in the other timelines to make the length thereof uniform.

In each timeline, the comparison points are displayed as the occurrence times of the respective events as the comparison points at positions relative to the implementation period of time of the work process represented by the timeline. For example, in the timeline for the work A, the event “Event 2” that is a comparison point occurs on December 3, that is, two days after the event “Event 1” that is the start position is performed. Accordingly, when 7 days that is the length of the timeline of the work A is set as 100%, the second day from the occurrence of the event “Event 2” is a time point when about 29% (=2/7) of the total temporal length elapses. In the timeline display of the work A illustrated in FIG. 5, the event “Event 2” as a comparison point is displayed at the position corresponding to 29% of the total temporal length from the start position to the end position. Likewise, in the timeline display of the work A, the event “Event 3” as a comparison point is displayed at the position corresponding to 71% (=5/7). In the timeline display of the work B, the events “Event 2” and “Event 3” as comparison points are respectively displayed at the positions corresponding to 15% (=2/13) and 85% (=11/13) of the total temporal length from the start position to the end position. In the timeline display of the work C, the events “Event 2” and “Event 3” as comparison points are respectively displayed at the positions corresponding to 29% (=2/7) and 71% (=5/7) of the total temporal length from the start position to the end position. In the timeline display of the work D, the events “Event 2” and “Event 3” as comparison points are respectively displayed at the positions corresponding to 29% (=4/14) and 71% (=10/14) of the total temporal length from the start position to the end position.

As described above, the numbers of days respectively taken to perform the work processes of the work A to the work D are different from each other; however, the length of each timeline is made uniform, and the occurrence time of each event as the comparison point is displayed at the relative position. It is thus possible to compare the occurrence time points of the events as the comparison points in the entire work process. From the example illustrated in FIG. 5, it is understood that the events “Event 2” and “Event 3” in the work process of the work B respectively occur earlier and later than in the other work processes.

### Method for Designating Base Points of Work Process

The method for designating base points (the start position and the end position) of a work process for timeline display in the target work will be described by taking a specific example. The base points are determined on the basis of the structure of the work process. It is thus conceivable that the base points are designated by using work segments and events. The work segments are defined on the basis of the progress of the work. The events are elements of the structure of the work process and occur in the progress of the work.

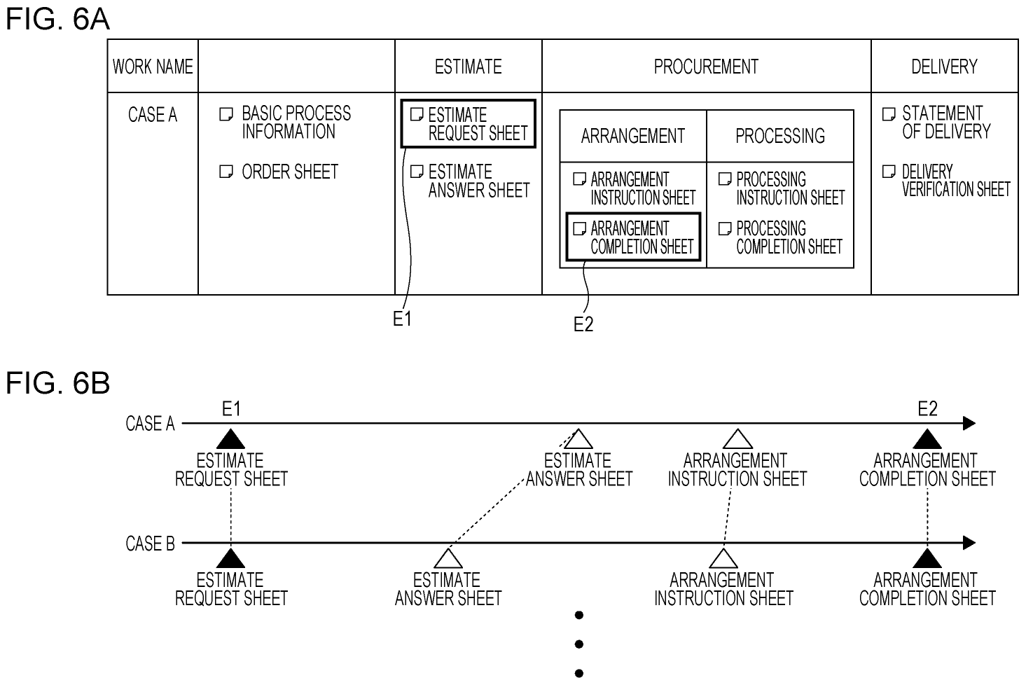

FIGS. 6A and 6B are diagrams illustrating an example method for designating base points of a work process. FIG. 6A is a diagram illustrating the structure of a work process, and FIG. 6B is a diagram illustrating timeline display. FIGS. 6A and 6B illustrate an example in which events occurring in the work process are designated as the base points. In FIG. 6A, the work process is divided into four work segments, and the third work segment (procurement) is further divided into two work segments. Items in each work segment represent events that each occur when work in the work segment in the work process is performed. In the work process illustrated in FIG. 6A, the work progresses from the left work segment toward the right work segment. In one work segment, events corresponding to the items occur in order from the top while the work is being in progress.

With reference to FIG. 6A, an event E1 that is estimate request sheet generation (Estimate Request Sheet in FIG. 6A) and an event E2 that is arrangement completion sheet generation (Arrangement Completion Sheet in FIG. 6A) are designated as the base points. The event “estimate answer sheet” and the event “arrangement instruction sheet” between the event E1 and the event E2 are determined as comparison points.

With reference to FIG. 6B, the timeline having the event E1 “estimate request sheet” as the start position, the event E2 “arrangement completion sheet” as the end position, and the events “estimate answer sheet” and “arrangement instruction sheet” as the comparison points is generated. Generating similar timelines for a case A, a case B, and . . . enables the occurrence times of the respective events as the comparison points to be compared and evaluated for each case.

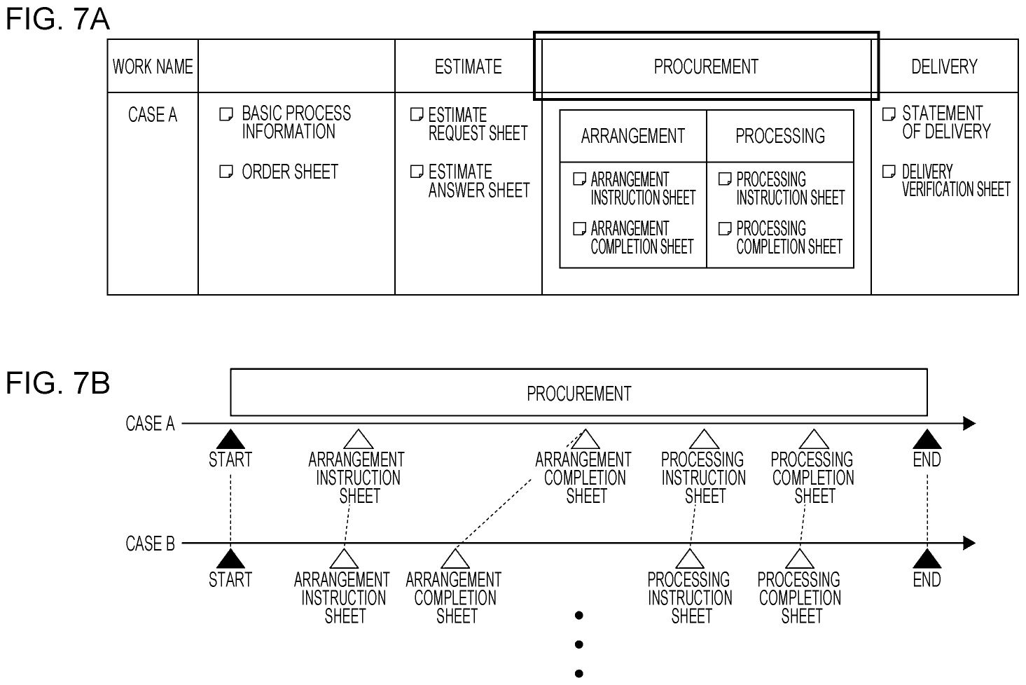

FIGS. 7A and 7B are diagrams illustrating a different example method for designating base points of a work process. FIG. 7A is a diagram illustrating the structure of the work process, and FIG. 7B is a diagram illustrating timeline display. FIGS. 7A and 7B illustrate an example in which a work segment in the work process is determined to thereby designate the base points. The structure of the work process illustrated in FIG. 7A is the same as the structure of the work process illustrated in FIG. 6A.

With reference to FIG. 7A, the work segment “procurement” is determined, and thereby the start time and the end time of the work segment are designated as the base points. The events “arrangement instruction sheet”, “arrangement completion sheet”, “processing instruction sheet”, and “processing completion sheet” that occur in the progress of the work segment “procurement” are thereby determined as the comparison points.

With reference to FIG. 7B, a timeline having the start time of the work segment “procurement” determined as the base point as the start position, the end position determined as the base point as the end position, and the events “arrangement instruction sheet”, “arrangement completion sheet”, “processing instruction sheet”, and “processing completion sheet” that are determined as the comparison points is generated. Generating similar timelines for the case A, the case B, and . . . enables the occurrence times of the respective events as the comparison points to be compared and evaluated for each case.

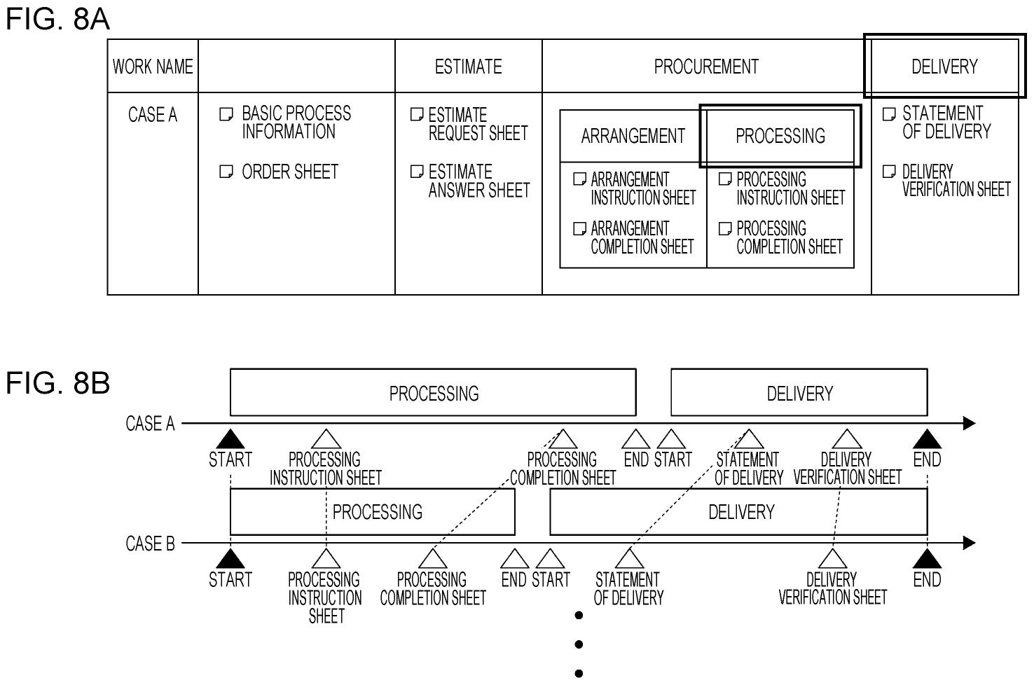

FIGS. 8A and 8B are diagrams illustrating a different example method for designating base points of a work process. FIG. 8A is a diagram illustrating the structure of the work process, and FIG. 8B is a diagram illustrating timeline display. FIGS. 8A and 8B illustrate an example in which multiple continuous work segments in the work process are determined to thereby designate the base points. The structure of the work process illustrated in FIG. 8A is the same as the structure of the work process illustrated in FIG. 6A.

With reference to FIG. 8A, multiple work segments “processing” and “delivery” are determined, and thereby the work segments are designated. In the case where the multiple continuous work segments are designated, a timeline is generated as one work process having the start time of the work segment for the first implementation determined as the start position and the end time of the work segment for the last implementation determined as the end position. In the example illustrated in FIG. 8A, the work segment “processing” and the work segment “delivery” are continuous in the work process, and thus the start time of the work segment “processing” for earlier implementation and the end time of the work segment “delivery” for later implementation are designated as the base points. The events “processing instruction sheet”, “processing completion sheet”, “statement of delivery”, and “delivery verification sheet” that occur while the specified work process is being in progress are determined as the comparison points.

With reference to FIG. 8B, a timeline having the start time of the work segment “processing” determined as a base point as the start position, the end time of the work segment “delivery” determined as a base point as the end position, and the events “processing instruction sheet”, “processing completion sheet”, “statement of delivery”, and “delivery verification sheet” that are determined as the comparison points is generated. Generating similar timelines for the case A, the case B, and . . . enables the occurrence times of the respective events as the comparison points to be compared and evaluated for each case.

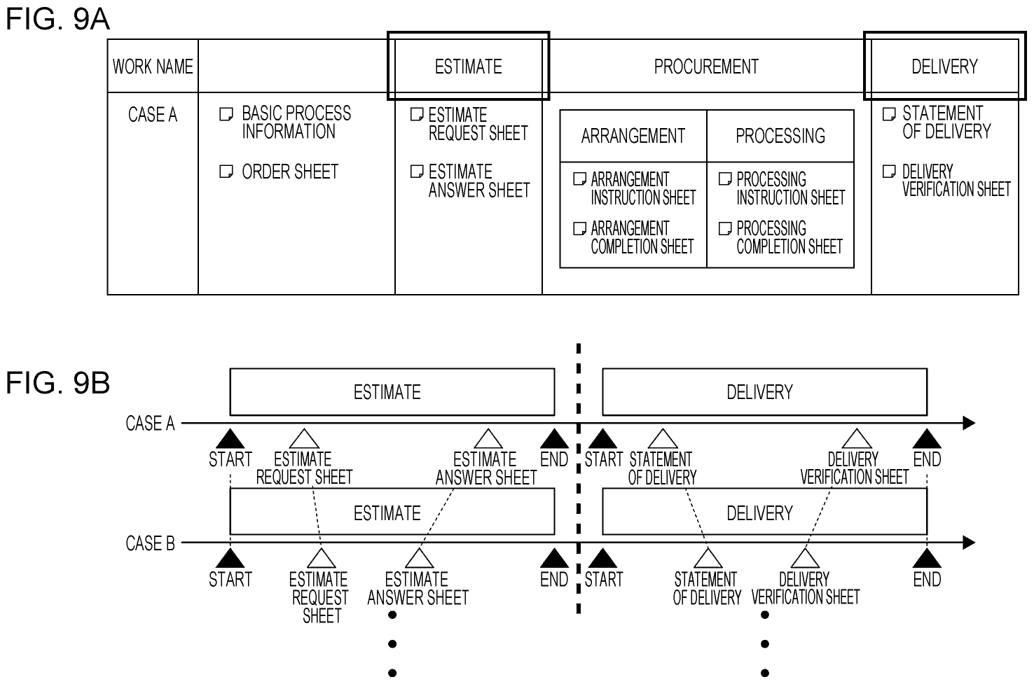

FIGS. 9A and 9B are diagrams illustrating a different example method for designating base points of a work process. FIG. 9A is a diagram illustrating the structure of the work process, and FIG. 9B is a diagram illustrating timeline display. FIGS. 9A and 9B illustrate an example in which the multiple incontinuous work segments in the work process are determined to thereby designate the base points. The structure of the work process illustrated in FIG. 9A is the same as the structure of the work process illustrated in FIG. 6A.

With reference to FIG. 9A, the multiple work segments “estimate” and “delivery” are determined, and thereby the work segments are designated. In a case where the multiple incontinous work segments are designated, timelines are respectively generated as individual work processes for the respective designated work segments. In the example illustrated in FIG. 9A, for each of the work segments “estimate” and “delivery”, a timeline having the start time and the end time thereof as the base points is generated. In the timeline for the work process of the work segment “estimate”, the events “estimate request sheet” and “estimate answer sheet” are thus determined as comparison points. In the timeline for the work process of the work segment “delivery”, the events “statement of delivery” and “delivery verification sheet” are determined as comparison points.

With reference to FIG. 9B, the timelines are respectively generated for the work process of the work segment “estimate” and the work process of the work segment “delivery”. In each timeline, the start time of the corresponding work segment is determined as a base point as the start position, the end time is determined as a base point as the end position, and the events that occur in the corresponding work segment are determined as the comparison points. Generating similar timelines for the case A, the case B, and . . . enables the occurrence times of the respective events as the comparison points to be compared and evaluated for each timeline of the corresponding work.

### Prediction of Progress of Scheduled Work Process

It is conceivable that on the basis of multiple timelines generated on the basis of a work process of one type, the progress of a scheduled work process of a type identical to that of the work process is predicted by using the timeline display of this exemplary embodiment. Specifically, on the basis of the positions of comparison points in the timeline display of each of the work processes performed in the past, times when events as comparison points in the scheduled work process that correspond to those in the past work processes are predicted.

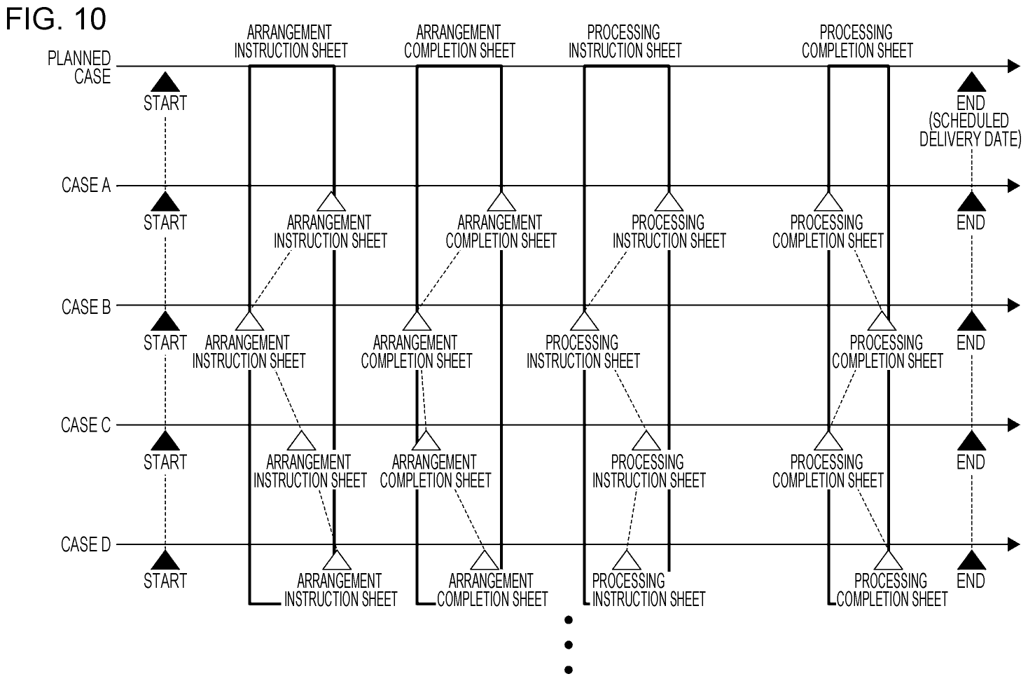

FIG. 10 is a diagram illustrating an example of timeline display used for predicting the work process progress. In the example illustrated in FIG. 10, timelines are displayed for the case A to a case D that are work processes performed in the past. In addition, the timeline of a planned case as a work process scheduled to be performed is displayed in correlation with the timeline display. The timeline of the planned case is displayed in such a manner that the start position and the end position (a scheduled delivery date in the planned case) are aligned with those of the timelines of the cases A to D and the total timeline length of each timeline is made uniform. Note that comparison points are not displayed in the timeline of the planned case.

In the timelines of the past work processes, an area extending from the comparison point position closest to the start position to the comparison point position closest to the end position is determined regarding each correlated comparison point. The area determined regarding the correlated comparison point is displayed on the timeline of the planned case. For example, when attention is focused on the comparison points of the event “arrangement instruction sheet” in FIG. 10, the comparison point arranged closest to the start position is the comparison point in the case B. In contrast, the comparison point arranged closest to the end position is the comparison point in the case D. An area extending from the arrangement position of the comparison point of the event “arrangement instruction sheet” in the case B to the arrangement position of the comparison point of the event “arrangement instruction sheet” in the case D is determined, and the area is displayed on the timeline of the planned case. In the example illustrated in FIG. 10, a strip having a width from the arrangement position of the comparison point of the event “arrangement instruction sheet” in the case B to the arrangement position of the comparison point of the event “arrangement instruction sheet” in the case D is drawn, and thereby the width of the strip indicates a predicted position of the occurrence of the event “arrangement instruction sheet” in the timeline of the planned case.

### Work Process Evaluation

Evaluating a work process performed in the past by using the timeline display of this exemplary embodiment is conceivable. Specifically, timeline display based on a work design model or the best practice case in the past is set as a reference timeline. In comparison with the reference timeline, a past work process in a different timeline is evaluated.

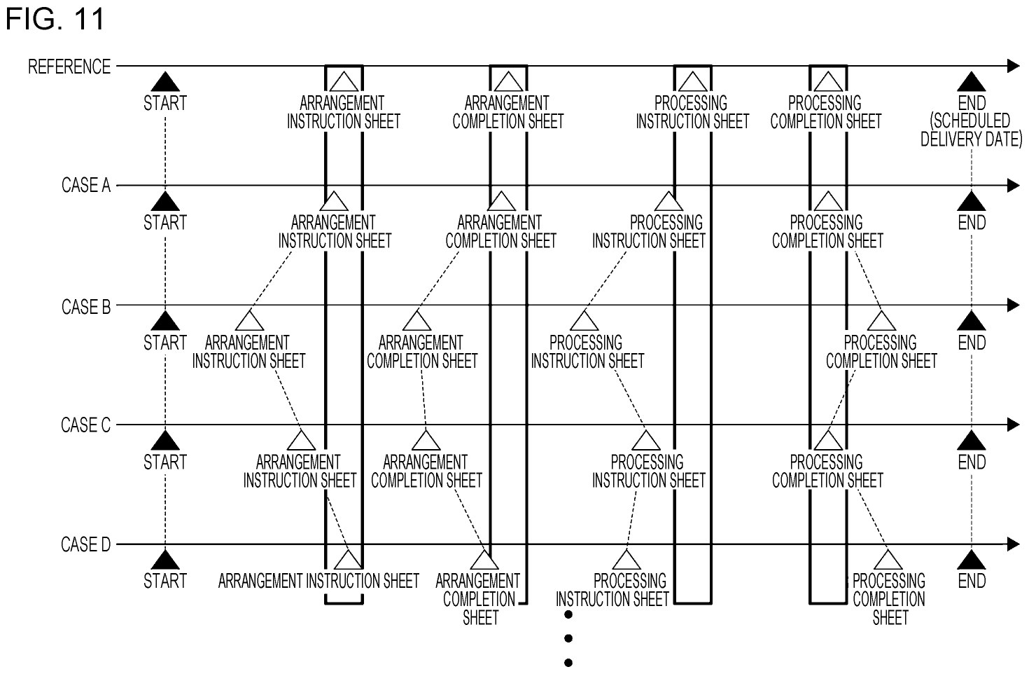

FIG. 11 is a diagram illustrating an example of timeline display used for the work process evaluation. In the example illustrated in FIG. 11, the reference timeline and the timelines of the respective cases A to D that are the work processes performed in the past are displayed. In the display, the start position and the end position of in the reference timeline are aligned with those of each of the timelines of the cases A to D, and the total timeline length of each timeline is made uniform. In each timeline of a corresponding one of the cases A to D, the positions of comparison points in the reference timeline are displayed. In the example illustrated in FIG. 11, strips each indicating the position of a comparison point in the reference timeline are drawn in such a manner as to run through the timelines of the cases A to D. Accordingly, a position at which each timeline of a corresponding one of the cases A to D crosses the drawn strip corresponds to the position of the comparison point in the reference timeline. With reference to the timeline display, an evaluator compares the positions of the comparison points in the respective timelines of the cases A to D with the corresponding position of the comparison point in the reference timeline, verifies shifts of the positions, and may thereby evaluate whether events in the respective work processes occur at approximately the same time.

The exemplary embodiment of the present disclosure has heretofore been described; however, the technical scope of present disclosure is not limited to that of the aforementioned exemplary embodiment. For example, in the exemplary embodiment described above, when a work process for generating a timeline is decided in such a manner that the base points are designated, the work data acquisition unit 130 of the work management system 100 automatically determines the comparison points. However, a user may select the comparison points for the comparison. In this case, among the comparison points determined by the work data acquisition unit 130, the user may select and eliminate an unnecessary comparison point. In addition, the present disclosure includes various modifications and replacements of the configuration without departing from the scope of the technical spirit of the present disclosure.

In the embodiment above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a processor configured to
display pieces of time series information regarding respective work processes on a display,
receive designation of timeframes of the respective work processes,
determine comparison points respectively included in the designated timeframes of the respective work processes,
for each work process represented by a plurality of pieces of work data to be compared,
mutually correlate the designated timeframes corresponding to each other, mutually correlate the determined comparison points corresponding to each other, and calculate a relative temporal position of each comparison point in the corresponding timeframe, and
make uniform a length of each timeframe of a corresponding one of the work processes and display, on the display, each piece of time series information indicating the comparison point at the relative temporal position.

2. The information processing system according to claim 1,
wherein the processor receives the designation of each timeframe after a start position and an end position of the timeframe are determined on a basis of a structure of a corresponding one of the work processes that includes at least one work segment and events, the at least one work segment being a segment defined on a basis of progress of work, the events occurring in the progress of the work.

3. The information processing system according to claim 2,
wherein the processor receives designation of the events occurring in the work process, respectively, as the start position and the end position of the timeframe.

4. The information processing system according to claim 2,
wherein the processor receives designation of the at least one work segment in the work process and determines a start position and an end position of the designated work segment, respectively, as the start position and the end position of the timeframe.

5. The information processing system according to claim 4,
wherein in a case where one work segment of the work segments is designated, the processor determines the start position and the end position of the work segment, respectively, as the start position and the end position of the timeframe.

6. The information processing system according to claim 4,
wherein in a case where continuous work segments of the work segments are designated, the processor determines a start position of a foremost work segment of the continuous work segments and an end position of a rearmost work segment of the continuous work segments, respectively, as the start position and the end position of the timeframe.

7. The information processing system according to claim 4,
wherein in a case where incontinuous work segments of the work segments are designated, the processor sets a timeframe for each work segment and determines a start position and an end position of the work segment, respectively, as a start position and an end position of the set timeframe corresponding to the work segment.

8. The information processing system according to claim 1,
wherein the processor predicts progress of a scheduled work process of the work processes on a basis of pieces of time series information included in the pieces of time series information and regarding corresponding ones of the work processes that are of a type identical to a type of the scheduled work process.

9. The information processing system according to claim 8,
wherein the processor
displays time-series progress information indicating the predicted progress of the scheduled work process and the pieces of time series information regarding the work processes of the identical type, with a length of a timeframe of the time-series progress information and lengths of respective timeframes of the pieces of time series information regarding the work processes of the identical type being made uniform,
determines an area regarding each of comparison points mutually correlated and respectively included in the pieces of time series information regarding the work processes of the identical type, the area extending from a comparison point position closest to a start position of a corresponding one of the timeframes to a comparison point position closest to an end position of the corresponding time frame, and
displays, in the time-series progress information, the area determined regarding the comparison point.

10. An information processing system comprising:
processing means for
displaying pieces of time series information regarding respective work processes on a display,
receiving designation of timeframes of the respective work processes,
determining comparison points respectively included in the designated timeframes of the respective work processes,
for each work process represented by a plurality of pieces of work data to be compared,
mutually correlating the designated timeframes corresponding to each other, mutually correlating the determined comparison points corresponding to each other, and calculating a relative temporal position of each comparison point in the corresponding timeframe, and
making uniform a length of each timeframe of a corresponding one of the work processes and displaying, on the display, each piece of time series information indicating the comparison point at the relative temporal position.
